(19) United States
(12) Patent Application Publication
(10) Pub. No.: US 2005/0195088 A1
(43) Pub. Date: Sep. 8, 2005

(54) RF smoke sensing system with integrated smoke/heat sensing christmas ornament transmitter

(76) Inventor: David M. Solak, (US)

Correspondence Address: DAVID M. SOLAK, 4805 MAPLE HILL DRIVE, SEVEN HILLS, OH, 44131, US

(21) Appl. No.: 10/792,357

(22) Filed: Mar. 4, 2004

(51) Int. Cl. G08B 17/10

(52) U.S. Cl. 340/628; 340/506; 340/539.1; 340/514

(57) ABSTRACT

This invention is an improvement on typical operating smoke sensors or detectors. By allowing remote detection of smoke/heat, the RF signal detectors presented in this document can turn on their alarms when smoke is detected in other rooms and not by all the detectors in a group. The number of detectors in a group is only limited by the size of the structure in which they are installed. During the winter holidays a Christmas tree smoke/heat detector can be hung on the Christmas tree to give advanced warning if the tree was to ignite. The ornament can transmit to the other detectors in a group, turning all alarms on so anyone in the structure can hear an early warning signal and then hopefully abandon the structure in time.

### BACKGROUND OF INVENTION

1. Field of Invention

This invention improves previous attempts to monitor potential fire conditions with RF Integrated smoke detectors. Residential and commercial facilities could use this invention for effectively sensing fire hazards during normal non-seasonal holidays and seasonal holidays such as Christmastime. With proper engineering, each smoke sensor or “detector” can be capable of sending and transmitting RF signals to other detectors in a system or “group”. There can be many detectors in a group depending on the requirements of each structure. Smaller structures would need less detectors in a group. A larger structure would require more detectors. In a residential setting, many families like to install a Christmas tree during the winter holiday season. This system intends to utilize a Christmas tree ornament that sends RF signals when heat or smoke is detected on or near the tree. By engineering corresponding signals between the ceiling detectors and the ornament, the tree can be integrated into the system at Christmastime.

2. Description of Prior Art

This invention allows complete coverage of fire sensing in a structure since each detector can function as a primary sensor then send a signal to the others in a group. Each smoke detector can then sound its alarm including the one that sensed the smoke. A Christmas RF smoke sensor ornament can be integrated into the system by simply hanging it on the tree during the holiday season. A temperature sensing wireless smoke detector was patented and known as prior art, U.S. Pat. No. 6,084,522 issued Jul. 4, 2000 to Addy, assigned to Pittway Corp. This system does not integrate smoke sensors that can send and receive RF signals. Furthermore it does not integrate a RF Christmas ornament into it's system. U.S. Pat. No. 6,420,973 issued Jul. 16, 2002 to Acevedo does not have the characteristics of this invention by not having the capability to sense smoke in any room and then transmit a signal to others in a group. This patent can only sense smoke where the primary detector is installed. Then it transmits to the other detectors in the group. For instance; one of the drawings in this patent (FIG. 1) shows ignition in the kitchen. The receivers in the group sound their alarms. If ignition is in the bedroom the system does not have the capability to sound the others in the group including the kitchen. This patent does not incorporate the ornament as a detector.

### SUMMARY OF INVENTION

With proper design this invention can be a viable way to detect smoke in a room and sound all detectors in a group within a structure. Each detector can function as a primary sensor by detecting the smoke and then transmitting the RF signal to the others in the group. Each detector can receive instruction to sound it's alarm from another in the group. If a fire occurs in a bedroom upstairs, the detectors on the first floor and the basement will sound there alarms also. The number of detectors is limited to only the size of the structure. During Christmas a RF smoke/heat sensing ornament can be hung on the Christmas tree if desired for added protection of fire occurring near or on the tree. The RF ornament's frequency signal will match that of the “ceiling” detectors.

### BRIEF DESCRIPTION OF THE DRAWINGS

FIG. 1. Shows how a grouping can send signals to the others in a system.

FIG. 2. Shows the Christmas ornament integrated into the system

FIGS. 3,4,5. Are block diagrams showing how a system works during the non-holiday season

FIG. 6. Is a block diagram showing how a system works during the holiday season

FIG. 7. Shows the schematic of the inner workings of the circuit

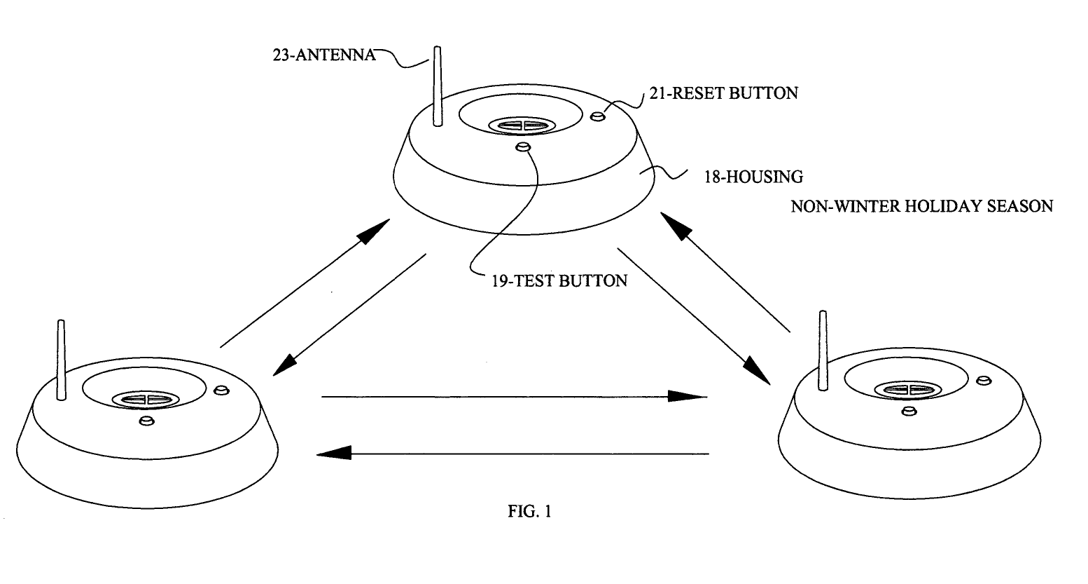

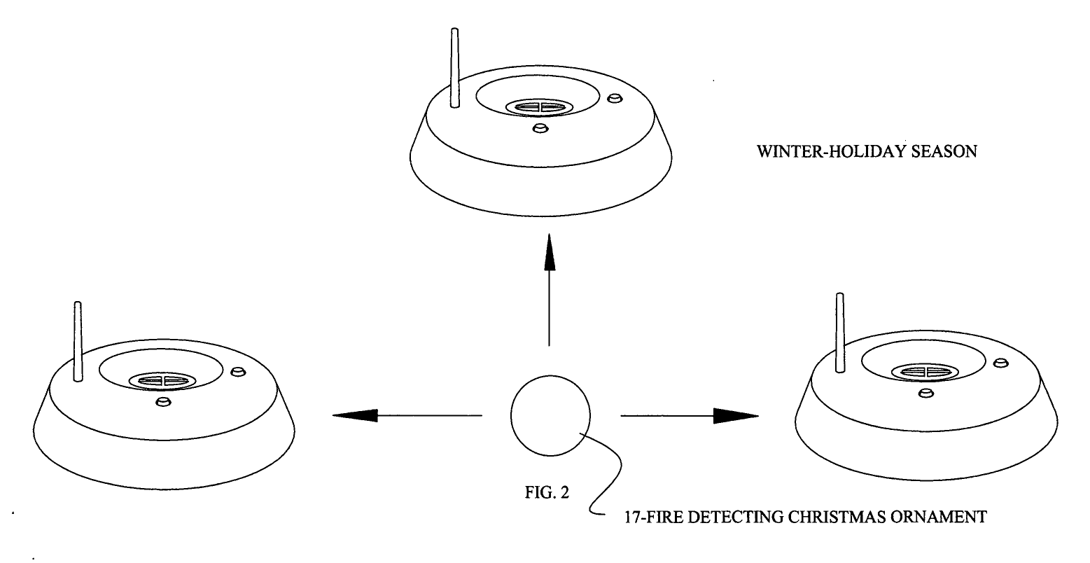

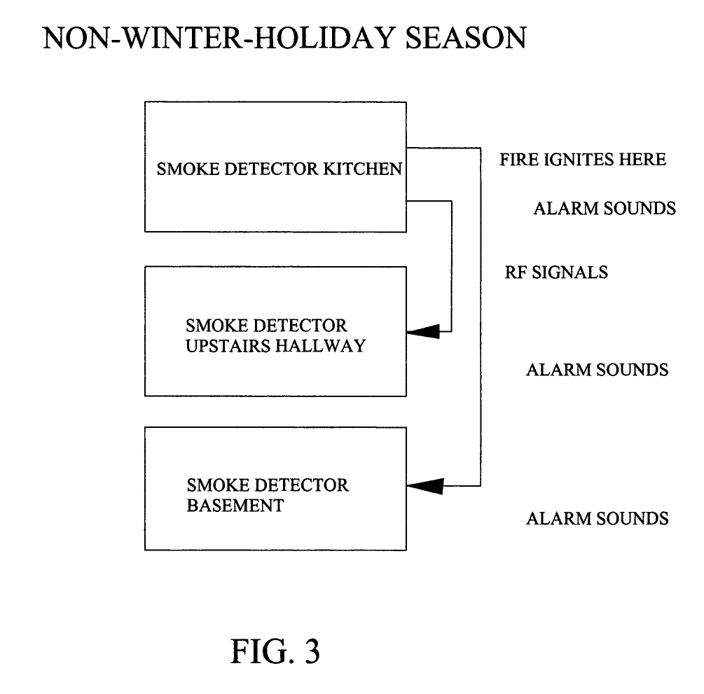

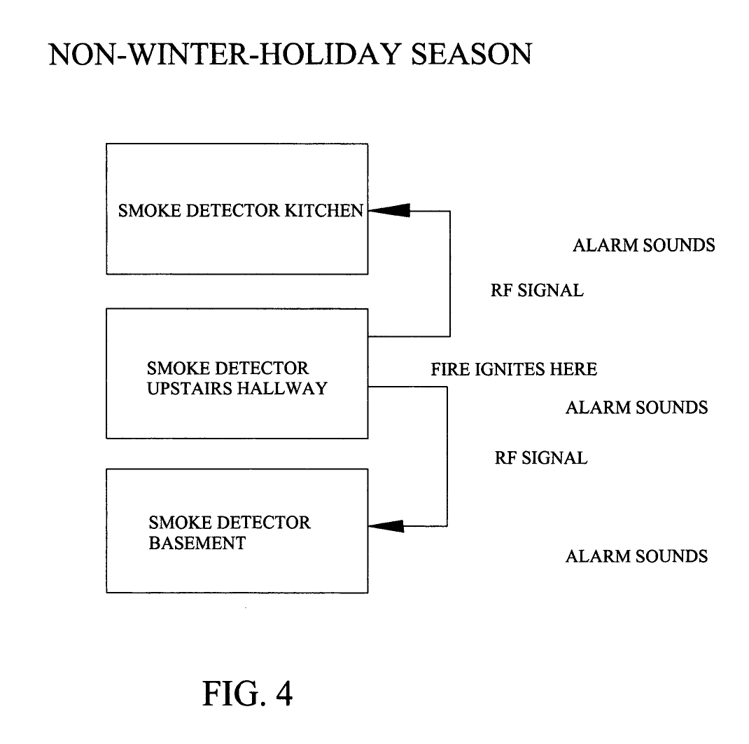

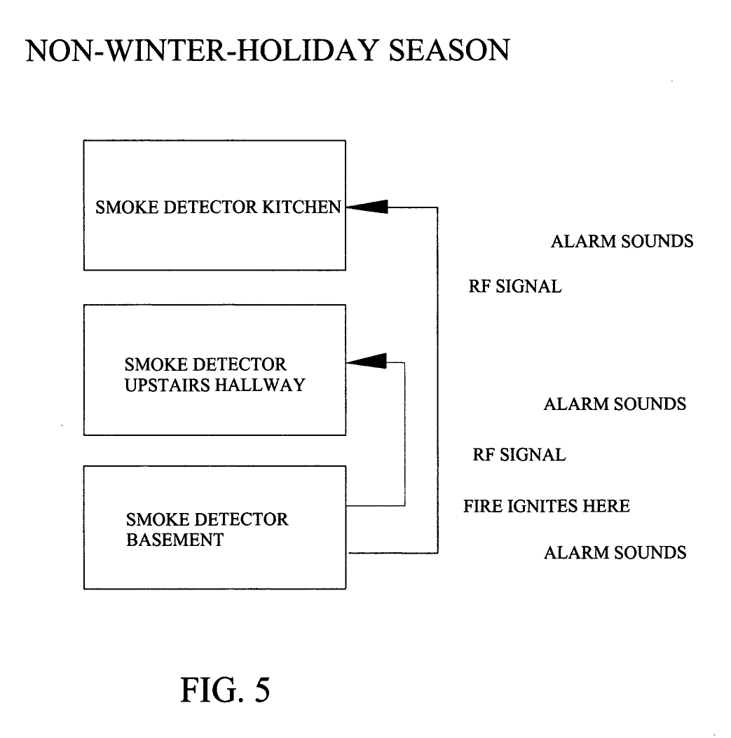

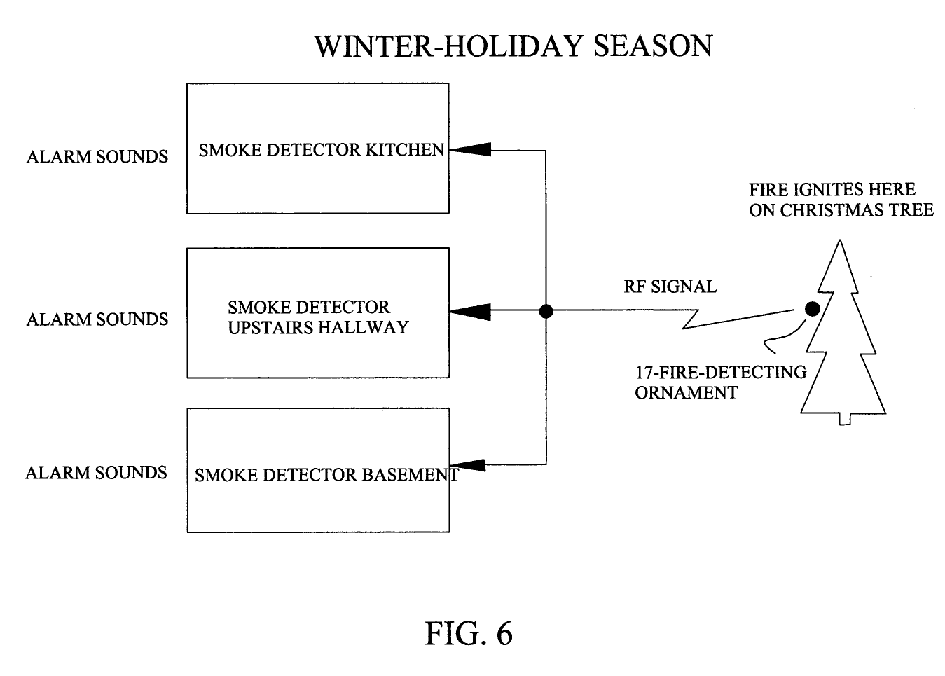

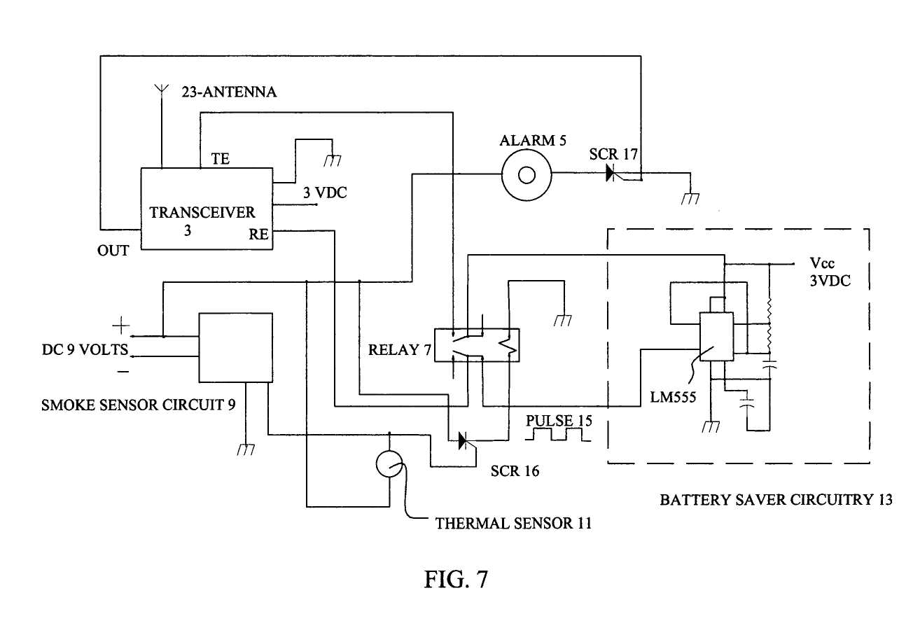

### DETAILED DESCRIPTION OF INVENTION

This smoke sensing system will turn on their alarms 5 by remote control through radio frequency transmission and reception. The smoke detectors have all the characteristics of other smoke sensors in prior art except they are capable of sending and receiving RF signals in each unit. A transceiver 3 or transmitter/receiver combination is activated by a smoke sensor circuit 9 through a relay 7 that is latched by an SCR 16. A Battery saver circuit 13 provides a pulsing voltage 15 through the relay 7. An alarm 5 sounds when the SCR 17 is triggered by the output of the transceiver 3. The transceiver 3 remains in receive mode until a signal from another smoke detector is received. When the smoke sensor circuit triggers, the DPDT relay 7 changes the transceiver 3 from receive mode into transmit mode. A thermal sensor 11 is incorporated into the system to detect heat. An antenna 23 allows for transmission and reception quality. A housing 18 can enclose all internal components. The fire detecting Christmas tree ornament 17 can detect fire or smoke on or near the tree during the winter holiday season.

1. A wireless smoke sensing system, comprising:
(a) multiple smoke sensors capable of sending and receiving RF signals, and
(b) each detector having the proper circuitry such as a transceiver system to alarm, send and receive signals by themselves, therefore
(c) a smoke sensor can receive an RF signal to turn on an audible warning alarm, and
(d) a smoke sensor as claimed in 1. (c) that can alarm and transmit a RF signal from inside the same housing of the receiver, allowing
(e) each smoke sensor to alarm and transmit to the others in a group, and
(f) a timer activated pulsing circuit to shut on and off the power to the transmission and reception means, saving battery life, and
(g) a SCR (Silicone Controlled Rectifier) to latch the reception and transmission of RF signals, and
(h) antennas to increase the transmission and reception qualities

2. A wireless Christmas Tree smoke and heat sensing bulb, incorporating:
(a) a RF signal that corresponds to the frequency of signals of the smoke sensors in claim 1, and
(b) a test button to prove the system is in operating condition
